(19) United States
(12) Patent Application Publication
(10) Pub. No.: US 2004/0181452 A1
(43) Pub. Date: Sep. 16, 2004

(54) System, method and apparatus for selling gift certificates and store credits

(76) Inventor: Cedric G. DeLaCruz, Maplewood, NJ (US)

Correspondence Address: Cedric G. DeLaCruz, 682 Prospect Street, Maplewood, NJ, 07040, US

(21) Appl. No.: 10/812,624

(22) Filed: Mar. 30, 2004

Related U.S. Application Data
(63) Continuation of application No. 09/518,968, filed on Mar. 4, 2000, now abandoned.

(51) Int. Cl. G06F 17/60

(52) U.S. Cl. 705/14; 705/26

(57) ABSTRACT

A system and method for selling gift certificates and/or store credits such that unused and unwanted gift certificates and/or store credits may be auctioned off. Sellers gift certificates and/or store credits are combined in auction and sold off as a single item. Bidders may bid on the combined gift certificates and/or store credits via the Internet.

This is a continuation of application Ser. No. 09,518,968 filed Mar. 3, 2000.

### BACKGROUND

The invention relates generally to the field of online auctions, especially for gift certificates and/or store credits. Many people return merchandise they purchased or are given for many reasons. Sometimes, the item does not function as they desired, sometimes the merchandise may not fit properly as in the case of clothing and sometimes the buyers may just decide they did not need the merchandise. This phenomenon is more prevalent during the post Holiday season, such as after Christmas, when people return merchandise which was given to them as presents. Many times, these people do not have the proper receipts and thus are given store credit. Typically stores do not give “cash” refunds for gifts or merchandise purchased, especially if the buyer does not have a valid store receipt. Many stores also have an only merchandise credit option for returns.

Accordingly, many consumers have store credit at stores they either do not need anything at or wish to purchase from. Many people also receive gift certificates for stores they do not need anything at or do not wish to purchase from. Furthermore, even if a person uses a gift certificate at a store, it is almost impossible hard to use up the entire value of the certificate since the certificates are typically in the whole dollar amount such as $20, $50 and $100. Thus many consumers have store credit or remaining gift certificates in odd dollar amounts such as $5.23, $12.11 and $23.98. Many times it is difficult to purchase items with the remaining values on gift certificates or store credits since typically the purchaser already has the goods they needed from the store and may not wish to contribute some of their own funds to supplement any remaining credit. However, stores typically will not give cash for remaining credit since they want to encourage the consumer to spend more money at the given store or e-commerce site.

Accordingly, it would be desirable to have a way to sell unwanted gift certificates or store credit and remaining values on gifts certificates or store credits.

### SUMMARY OF THE INVENTION

The present invention is a system, method and apparatus for selling gift certificates and/or store credits to one or more bidders on the Internet. The present invention involves combining gift certificates and/or store credits from sellers for auction as a single item, receiving, from one or more bidders, at least one bid for the single item and selling the single item to a winning bidder, wherein the winning bidder receives the combined gift certificates and/or store credits. A system and apparatus is also disclosed for facilitating a transaction between a buyer and at least one of a plurality of sellers which includes a storage device; and a processor connected to the storage device, the storage device storing a program for controlling the processor and the processor operative with the program to receive a plurality of gift certificates and/or store credits for auction, combine two or more of the gift certificates and/or store credits, receive bids for the combined gift certificates and/or store credits, receive payment for the combined gift certificates and/or store credits; and provide payment to each of the sellers of the combined gift certificates and/or store credits.

### BRIEF DESCRIPTION OF THE DRAWINGS

FIG. 1 illustrates an embodiment of the present invention.

FIG. 2 is a block diagram showing one embodiment of the central controller.

FIG. 3 is a block diagram showing an exemplary process of the present invention.

### DETAILED DESCRIPTION OF THE INVENTION

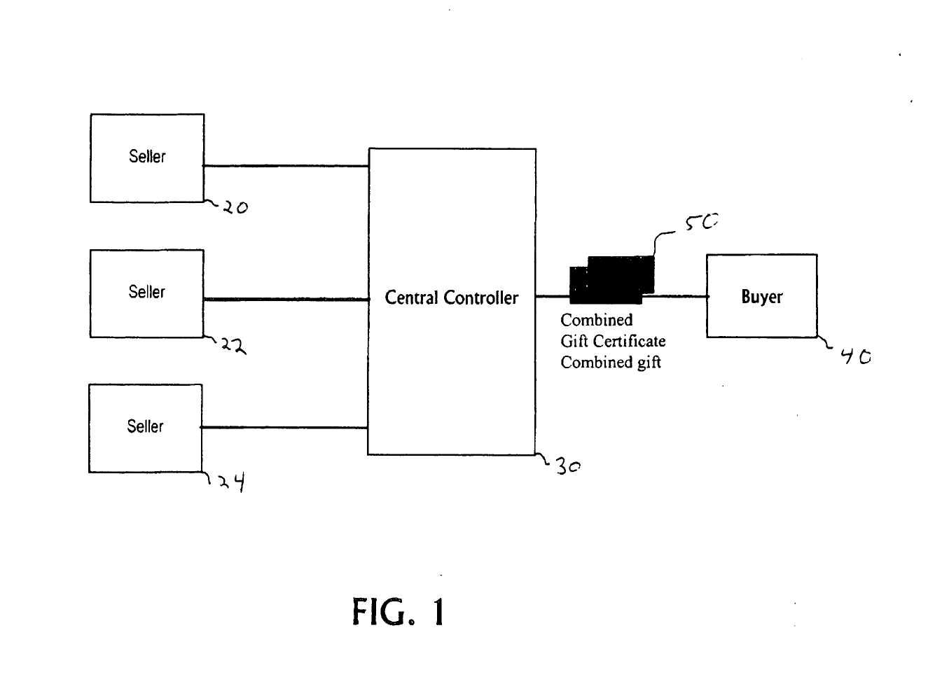

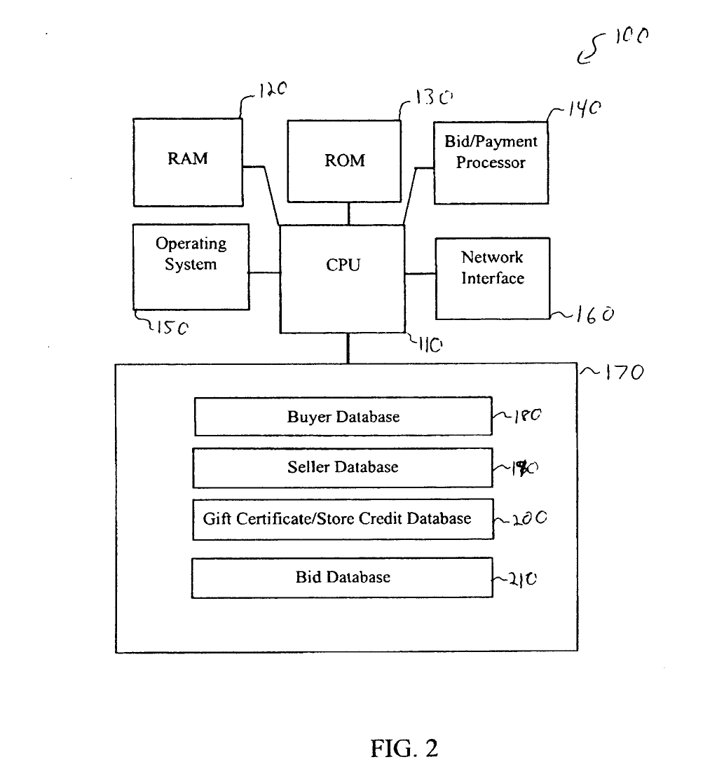

The system architecture of a first embodiment of the present invention is illustrated with reference to FIGS. 1 through 2. As shown in FIG. 1, the present invention comprises a plurality of sellers 20, 22 and 24, a central controller 30 and one or more buyers 40. In the present invention, two or more of the sellers' gift certificates and/or store credits are combined as a single item 50 and sold to one or more buyers via an online auction. The buyers and sellers are connected to the central controller 30 via an Internet connection using a public switched phone network, such as those provided by a local or regional telephone operating company or other connection may also be provided by dedicated data lines, coaxial, fiber, cellular, Personal Communication Systems (“PCS”), microwave, or satellite networks.

As shown in FIG. 2, central controller 100 includes central processor (CPU) 110, RAM 120, ROM 130, bid and payment processor 140, operating system 150, network interface 160, and data storage device 170. A conventional personal computer or computer workstation with sufficient memory and processing capability may be used as central controller 100. In one embodiment the central controller operates as a web server, administering the auction of the gift certificates and/or store credits. Central controller 100 must be capable of high volume transaction processing, performing a significant number of mathematical calculations in processing communications and database searches. A Pentium microprocessor commonly manufactured by Intel Inc., may be used for CPU 110. Other processors usable for CPU 110 are manufactured by companies such as Motorola Inc. and Sun Microsystems.

Referring again to FIG. 2, bid/payment processor 140 comprises one or more conventional microprocessors, supporting the transfer and exchange of payments, charges, or debits, attendant to the method of the apparatus. Bid/payment processor 140 may also be configured as part of CPU 110. Processing of credit card transactions by bid/payment processor 140 may be supported with commercially available software which transmits credit card numbers electronically over the Internet to perform card verification and processing is handled.

Data storage device 170 may include hard disk magnetic or optical storage units, as well as CD-ROM drives or flash memory. Data storage device 170 contains databases used in the processing of transactions in the present invention, including seller database 180, buyer database 190, combined gift certificates and store credits database 200 and a bid database 210. In a exemplary embodiment database software such as manufactured by Oracle Corporation, is used to create and manage these databases.

Buyer database 180 maintains data on buyers with fields such as name, address, credit card number, phone number, ID number, social security number, electronic mail address, credit history, past system usage, public/private key information, etc. This information is obtained when the buyer first registers with the system, or immediately prior to posting his first bid for gift certificates and/or store credits. Buyer database 180 also contains the tracking number of each bid generated by the buyer, and the tracking number of each seller response 110.

Seller database 190 maintains data on sellers with fields such as name, contact information, public/private key information, payment preferences, type of gift certificate(s) and/or store credit(s) the seller wishes to put up for auction, and the amount (face value) of each gift certificate(s) and/or store credit(s). This information is obtained when the seller first registers with the system or any subsequent time when the registered user logs onto the system to place their gift certificate(s) and/or store credit(s) up for auction.

Combined gift certificates and store credits database 200 maintains data on the gift certificates and store credits which have been combined for auction. Combined gift certificates and store credits database 200 also contains information on the names of sellers which have contributed gifts certificates and/stores credits to the combined items. Combined gift certificates and store credits database 200 may also contain information on any value limits placed on the items for auction, as discussed in more detail herein.

Bid database 210 maintains data on the various bids which are being placed or have been placed for items in the combined gift certificates and store credits database 200. Information such as asking price, limit price and current high bid may be contained in the bid database. In one embodiment, the combined gift certificates and store credits database 200 and bid database may be a single database.

Network interface 160 is the gateway to communicate with buyers and sellers through their respective interface. Conventional internal or external modems may serve as network interface 160. Network interface 160 supports modems at a range of baud rates, but may combine such inputs into a T1 or T3 line, coaxial, fiber or other similar high data transfer line if more bandwidth is required. In a preferred embodiment, network interface 160 is connectable with the Internet and/or any of the commercial on-line services such as America Online, CompuServe, or Prodigy, allowing buyers and sellers access from a wide range of on-line connections.

While the above embodiment describes a single computer acting as central controller 100, those skilled in the art will realize that the functionality can be distributed over a plurality of computers. In one embodiment, central controller 100 is configured in a distributed architecture, wherein the databases and processors are housed in separate units or locations. Some controllers perform the primary processing functions and contain at a minimum RAM, ROM, and a general processor. Each of these controllers is attached to a WAN hub which serves as the primary communication link with the other controllers and interface devices. The WAN hub may have minimal processing capability itself, serving primarily as a communications router. Those skilled in the art will appreciate that an almost unlimited number of controllers may be supported. This arrangement yields a more dynamic and flexible system, less prone to catastrophic hardware failures affecting the entire system.

In an exemplary embodiment, sellers and buyers communicate with the central controller and thus, to each other through an interface such as a personal computer, laptop, palmtop, wireless device and other similar device which has the ability to access the Internet. In an exemplary embodiment, the seller and buyer interfaces are both conventional personal computers having an input device, such as a keyboard, mouse, or conventional voice recognition software package; a display device, such as a video monitor; a processing device such as a CPU; and a network interface such as a modem. These devices interface with central controller 100. In one example, the buyers and sellers both use browser software and log into central controller through their respective Internet service providers and access a web site provided by the central controller. Through the web site, the buyers and sellers may perform tasks such as submit their gift certificates and/or store credits for auction, place bids for items and check on the status of pending and closed auctions.

In one embodiment of the present invention, communications between buyers and sellers take place via electronic networks, with central controller 100 acting as a web server. Sellers log on to central controller 100 and submit their respective gift certificates and/or store credits for sale at auction. The central controller will combine two or more sellers gift certificates and/or store credits as discussed in more detail later herein. One or more buyers log on to central controller 100 and submit one or more bids for the combined gift certificates and/or store credits. Typically, both sellers and buyers will use Internet browser software along with associated Internet Service Provider software to establish a connection to the central controller. In the present invention, the combined gift certificates and/or store credits are made available to potential buyers by posting them on the web page of central controller 200. Maintenance is performed by central controller 100 to administer the auctions, for example, to update bids and close sales for items where bidding has ended.

In one embodiment of the present invention, the central controller 100 combines two more sellers' respective gift certificates and/or store credits and places them up for auction. For example, if a seller A has a gift certificate with a face value of $10 up for auction and a seller B has a gift certificate with a face value of $15 up for auction, the central controller will combine seller A's $10 gift certificate with seller B's $15 gift certificate and put them up for auction as a single $25 gift certificate item. While a buyer will still receive separate $10 and $15 gift certificates, the buyer will not have to bid separately for seller A's gift certificate and seller B's gift certificate. Sellers may also voluntarily elect to join with each other to combine their gift certificates and/or store credits to auction them as one item. Ideally, the combined gift certificates and/or store credits will be usable at the same entity, such as a retail establishment. This entity may be a chain or stores, or even a series of unrelated stores which may be owned by the same entity and thus gift certificates and/or store credits at one store are honored at the other store. Thereby, a buyer of the combined gift certificates and/or store credits will be able to use the combined gift certificates and/or store credits at the retail establishment, such as a department store, speciality store or e-commerce site.

In the present invention, specific predetermined value thresholds may be set within central controller 100 to aid in determining which gift certificates and/or store credits to combine. For example, three value thresholds may be set at $25, $50 and $100 such that the central controller will combine seller's gift certificates and/or store credits in combinations which most closely match or approximate the three auction thresholds of $25, $50 and $100. For example, if a seller X has a store credit for $10.11, seller Y has a store credit for $30.01 and seller Z has a store credit $8.00, central controller will combine the store credits of seller X, seller Y and seller Z since the total amount of the combined store credits will equal $48.12, which is close to or approximates the auction threshold of $50. Typically, the system will predetermine such whole dollar values such as $25, $50 and $100 to most closely approximate with the combined gift certificates and/or store credits since these are values that consumers are used to identifying with items such as gift certificates but of course, any predetermined value threshold may be set.

If two or more combinations of gift certificates and/or store credits come close to two or more auction thresholds, central controller may simply randomly select which auction threshold amount to combine gift certificates and/or store credits to. Central controller may also combine gift certificates and/or store credits so as to have a generally equal amount of items for auction at each auction threshold, so that generally equal number of auction items are for sale at any one time at, in this example, the $25, $50 and $100 levels. Clearly, any monetary levels may be set for these auction thresholds so as to promote the auction of these items.

In the present invention, certain value limits may be placed on auction items. For example, if a combination of store credits is placed up for auction, where the total amount of the store credits equals $50.25, the auction value limit may be placed at $50.24 such that any bids over $50.24 will not be honored. Such bids over the auction value limit may be automatically reduced the actual auction value limit value. For example, if a bid for $51.00 is placed for the $50.25 store credit, the bid will be automatically reduced to $50.24 by the central controller 100. If two or more bidders place bids at or above the value limit set, then the first bidder who placed the bid at or above the value limit will have priority in the auction. In essence, the first bidder in time to equal or exceed the auction value limit will win the auction. The auction value limit may be set in any manner, such as a percentage of the total value of the combined gift certificates and/or store credits. For example, the auction value limit may be placed at 90 percent of the total value, so that an auction item with a combined value of $100, will have an auction value limit of $90. Typically, bidders will not likely be placing bids higher than the combined value of the auction items. Preferably, a value limit is set such that bids equal to 99.99% or less of the total value of the combined gift certificates and/or store credits are encouraged in the bidding process.

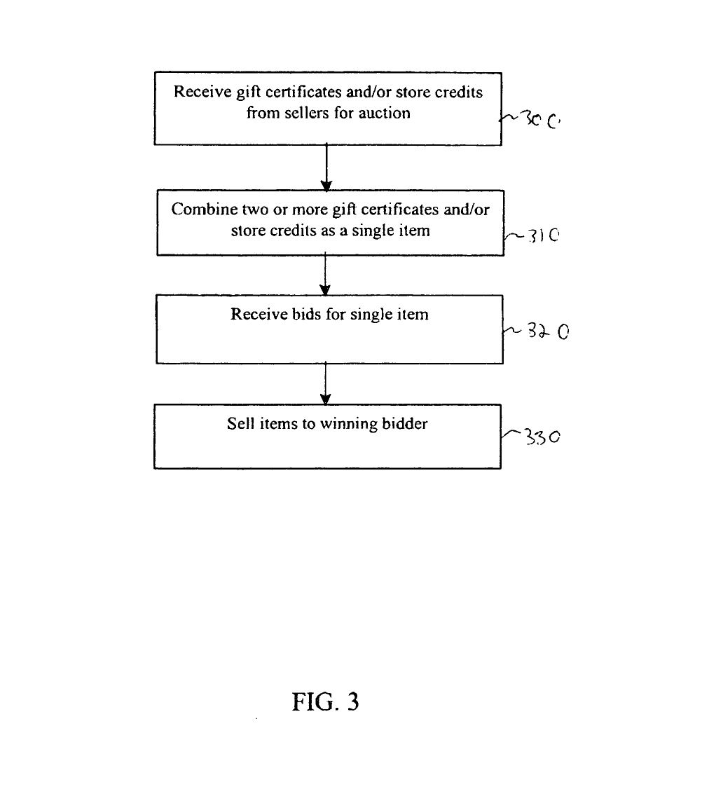

FIG. 3 illustrates an exemplary process of the present invention. The steps of the process shown in FIG. 3 may be implemented in a computer program that may be installed at the buyer and/or seller interface, such as a personal computer, from, for example, a computer readable medium (such as floppy disks or CD-ROMS) which is then which is then stored in a memory or storage device. Additionally, the computer program may be installed at the central controller 100 from a computer readable medium and then stored therein in one or more of ROM, RAM memory and data storage device, for access and user by the buyers and sellers. In the present invention, the central controller receives gift certificates and/or store credits from a plurality of sellers via their respective seller interfaces, step 300. Two or more of these gift certificates and/or store credits are combined and sold as a single item by the central controller, and/or by the sellers themselves through the central controller, step 310. Bids are received for these items by central controller 100, step 320. The items are sold to the winning bidders, step 330. In the present invention, auction time frames may be set either by the central controller or the sellers themselves such that an auction may be held for any time period, such as a day, week, month or other time frame.

Once payment is received from the winning bidder, the respective sellers whose gift certificates and/or store credits were combined will receive compensation for their gift certificates and/or store credits. Typically, a commission will be charged to each seller such that a nominal percentage such as from 1 percent to 15 percent of the value of each seller's respective gift certificates and/or store credits will be deducted by central controller 100. Of course, any commission percentage may be set. In another embodiment, the buyer or winning bidder will be charged the commission such that each respective seller, will receive the full value of their respective gift certificates and/or store credits which they placed up for auction.

Payment may be made by a buyer or winning bidder through any number of payment methods such as credit cards, debit accounts, checks, cash, electronic funds transfer and types of electronic cash or digital cash. Such funds may be collected by the central controller online or may be transacted through banks, financial services institutions or simply mailed. Typically, payment to the sellers will not occur until the buyer's funds have been received.

In another embodiment of the present invention, seller's gift certificates and/or store credits are authenticated prior to final sale of the gift certificates and/or store credits. For example, in one embodiment, the sellers will be required to send in their gift certificates and/or store credits to be authenticated, such as by comparing the gift certificates and/or store credits to known valid examples of the gift certificates and/or store credits.

While the present invention has been described above in terms of specific embodiments, it is to be understood that the invention is not limited to the disclosed embodiments. On the contrary, the present invention is intended to cover various modifications and equivalent structures included within the spirit and scope of the appended claims.

I claim:

1. A method for selling gift certificates and/or store credits to one or more bidders on the Internet, comprising:
combining gift certificates and/or store credits from two or more distinct sellers as a single item for auction, each gift certificate and/or store credit independently having an undesirable value associated with each one independently, wherein each of the gift certificates and/or store credits when combined represent a desirable combined value thereby rendering the combined value more usable at a single retail entity;
receiving, from or more bidders, at least one bid for the single item; and
selling the single item to a winning bidder, wherein the winning bidder receives the combined gift certificates and/or store credits.

2. The method of claim 1, wherein the two or more sellers' gift certificates and/or store credits are combined to approximate a certain predetermined value threshold.

3. The method of claim 1, wherein a value limit is set for winning bid for the single item, wherein the limit does not exceed the face value of each of the plurality of gift certificates and store credits and bids in excess of the predetermined value limit will be automatically reduced to the value limit.

4. The method of claim 1, wherein the sellers will split the proceeds of the sale of the single item according to the respective percentages their respective gift certificate and/or store credit contributed to the total value of the single item.

5. The method of claim 1 further comprising:
providing proceeds from the sale of the one or more gift certificates and/or store credits to the one or more sellers, wherein the proceeds is the sale price of the one or more gift certificates and/or store credits minus a commission.

6. The method of claim 1, further comprising:
receiving a payment from the winning bidder via a credit card.

7. The method of claim 1, wherein the predetermined value limit is at a maximum equal to 99.99% of the face value of the gift certificate and/or store credit.

8. A system for selling gift certificates and/or store credits, comprising:
means for combining gift certificates and/or store credits from two or more sellers;
means for receiving bids for the combined gift certificates and/or store credits; and
means for selling the combined gift certificates and/or store credits to one or more bidders.

9. The system of claim 8, wherein each of the two or more sellers will split the proceeds of the sale of the single item according to the respective percentages each contributed to the single item.

10. The system of claim 8, wherein the predetermined value limit is at a maximum equal to 99.99% of the face value of the gift certificate and/or store credit.

11. The system of claim 8, wherein the gift certificates and/or store credits are combined to approximate a predetermined whole dollar value.

12. The system of claim 8, further comprising:
means for deducting a commission from a selling price of the one or more gift certificates and/or store credits.

13. The system of claim 8, further comprising:
means for verifying the authenticity of the one or more gift certificates and/or store credits.

14. A method for auctioning a plurality of seller's gifts certificates and/or store credits to one or more bidders in an Internet auction, comprising:
combining the seller's gift certificates and/or store credits as a single item for auction, wherein each distinct gift certificate and/or store credit is undesirable when alone since each distinct gift certificate and/or store credit represent an undesirable amount alone but when combined represents a desirable amount for a bidder;
receiving bids for combined gift certificates and/or store credit; and
selling the gift certificates and/or store credits to a winning bidder.

15. The method of claim 14, further comprising:
receiving a payment from the winning bidder via a credit card.

16. The method of claim 14, further comprising:
deducting a commission from a selling price of the one or more gift certificates and/or store credits.

17. The method of claim 14, wherein the limit is in the range of about 90% to 99% of the face value of the gift certificate and/or store credit.

18. The method of claim 14, wherein two or more sellers can combine gift certificates and/or store credits from a common entity and sell the combined gift certificates and/or store credits as a single item.

19. The method of claim 14, further comprising:
validating the seller's gift certificates and/or store credits to verify that the gift certificate and/or store credit is valid.

20. The method of claim 14, wherein the step of combining the seller's gift certificates and/or store credits as a single item for auction includes the step of:
approximating a predetermined whole dollar value with the combined seller's gift certificates and/or store credits.

21. An apparatus for facilitating a transaction between a buyer and at least one of a plurality of sellers, comprising:
a storage device; and a processor connected to the storage device, the storage device storing a program for controlling the processor; and the processor operative with the program to
receive a plurality of gift certificates and/or store credits from two or more independent sellers for auction;
combine the sellers' gift certificates and/or store credits as a single item for auction since each of the gift certificates and/or store credits do not have a desirable value independently;
receive bids for the combined gift certificates and/or store credits;
receive payment for the combined gift certificates and/or store credits; and
provide payment to each of the sellers of the combined gift certificates and/or store credits.
